(19) United States
(12) Patent Application Publication
(10) Pub. No.: US 2023/0264394 A1
(43) Pub. Date: Aug. 24, 2023

(54) SYSTEM FOR THE PRODUCTION OF AT LEAST ONE PARTICLE FOAM MOLDING

(71) Applicant: Siegfried Hofmann GmbH, Lichtenfels (DE)

(72) Inventors: Johannes Schütz, Bamberg (DE); Marcus Schmiedeck, Flöha OT Falkenau (DE); Stefan Hofmann, Lichtenfels (DE); Jonas Beck, Bamberg (DE)

(21) Appl. No.: 18/043,657

(22) PCT Filed: Aug. 31, 2021
(86) PCT No.: PCT/EP2021/073968

§ 371 Date: Mar. 1, 2023

(30) Foreign Application Priority Data
Sep. 8, 2020 (DE) 10 2020 123 437.6

(51) Int. Cl. B29C 44/60; B29C 44/44; B29C 44/58

(52) U.S. Cl. CPC B29C 44/60; B29C 44/445; B29C 44/58; B29K 2105/04

(57) ABSTRACT

A system for producing at least one particle foam molding includes at least one automatic molding machine, which comprises at least one mold device. The automatic molding machine(s) comprises at least one interface for coupling a functional module which can be functionally assigned to the automatic molding machine(s) in order to form an individually configured automatic molding machine functional module arrangement. The system also includes at least one functional module which can be individually assigned to the automatic molding machine(s) to form an individually configured automatic molding machine functional module arrangement, wherein the functional module(s) comprises at least one interface for coupling to the automatic molding machine(s). Additionally, the system includes a central data processing device(s) which, on the basis of the configuration of the individually configured functional module arrangement, is configured to generate operating information which regulates and/or controls the operation of at least one functional module.

The invention relates to a system for producing at least one particle foam molding from an expandable or expanded particle foam material, comprising at least one automatic molding machine which comprises at least one mold device for processing expandable or expanded particle foam material for the production of a particle foam molding or particle foam molded part.

Corresponding systems is basically known from the field of processing expandable or expanded particle foam materials for the production of particle foam moldings from the prior art.

Essential components of corresponding systems are molding machines, which typically comprise at least one mold device for processing plastic particles from an expandable or expanded particle foam material to produce a particle foam molding.

In corresponding systems, functional modules, such as steam generators, are permanently assigned to the molding machines and perform specific functions in connection with the processing of expandable or expanded particle foam material that can be carried out by the molding machine.

The configuration of such systems, i.e. in particular the functional and structural coupling between the respective molding machines and the respective functional modules, has typically been centralized to date and thus requires a fixed arrangement or coupling of the respective molding machines and functional modules. For example, a known configuration of corresponding systems provides for a central steam generator that supplies one or more molding machines with steam.

Such a centralized and not individually configurable configuration of corresponding systems regularly results in a complex and cost-intensive infrastructure, e.g. due to the necessary laying of certain supply lines between the respective molding machines and functional modules.

On this basis, the invention is based on the task of providing an improved system for producing at least one particle foam molding from an expandable or expanded particle foam material, in particular with regard to the possibility of individual configuration of molding machines and functional modules.

This object is achieved by a system for producing at least one particle foam molding from an expandable or expanded particle foam material according to claim 1. The claims dependent thereon relate to possible embodiments of the system.

A first aspect of the invention relates to a system for producing at least one particle foam molding from an expandable or expanded particle foam material. Accordingly, the system is configured for processing plastic particles from at least one expandable or expanded particle foam material for producing particle foam moldings or particle foam components, and for this purpose comprises devices for carrying out one or more working processes for processing plastic particles from at least one expandable or expanded particle foam material for producing a particle foam molding.

The term “working process” basically includes any process which can be carried out by means of the system and which is directly or indirectly connected with the processing of plastic particles from at least one expandable or expanded particle foam material for the production of a particle foam molding. Accordingly, a working process may be a processing process in which the (actual) processing of corresponding plastic particles, i.e., in particular, a bonding of corresponding plastic particles to form a particle foam molding to be produced, takes place. Alternatively or supplementarily, a working process can be a providing process in which, for example, a quantity of corresponding plastic particles, in particular a quantity of corresponding plastic particles to be processed in a processing process, and/or a quantity of a supply medium or process fluid, in particular a quantity of a supply medium or process fluid to be processed in a processing process, is provided. Alternatively or additionally, a working process may be a conveying process in which, for example, a quantity of corresponding plastic particles, in particular a quantity of corresponding plastic particles to be processed in a processing process, and/or a quantity of a supply medium or process fluid, in particular a quantity of a supply medium or process fluid to be processed in a processing process, is conveyed along a conveying path. Alternatively or supplementarily, a working process can be a filling process in which, for example, a quantity of corresponding plastic particles, in particular a quantity of corresponding plastic particles to be processed in a processing process, is filled into a mold cavity of a mold device. Alternatively or additionally, a working process can be a treatment process in which, for example, a supply medium or process fluid, such as steam, water, etc., used in particular in a processing process, is treated.

The system thus comprises at least one automatic molding machine. The at least one automatic molding machine is configured for carrying out one or more processing processes for processing plastic particles from at least one particle foam material to produce a particle foam molding. The at least one automatic molding machine may therefore also be referred to or deemed to be an apparatus for processing plastic particles of at least one expandable or expanded particle foam material. The at least one molding machine typically comprises at least one mold device for processing plastic particles of at least one expandable or expanded particle foam material to produce a particle foam molding. The at least one mold device typically comprises at least one mold cavity definable or defined by one or more mold elements, within which plastic particles of at least one expandable or expanded particle foam material can be processed to form corresponding particle foam moldings. The at least one molding machine may comprise a housing-, frame- or rack-like structure, for example, on or in which at least the at least one mold device is arranged or formed.

The at least one automatic molding machine comprises at least one interface for coupling, in particular functionally and/or constructively, at least one functional module which can be functionally assigned or is assigned to the at least one automatic molding machine for forming an individually configured automatic molding machine functional module arrangement. The at least one interface can accordingly be a functional and/or constructive interface. A corresponding interface can therefore be configured to establish a functional and/or constructive coupling of a corresponding automatic molding machine with at least one functional module that can be functionally assigned or is assigned to the at least one automatic molding machine for forming an individually configured automatic molding machine functional module arrangement. Respective interfaces on the side of the molding machine are in particular configured to cooperate with respective interfaces on the side of the functional module to form an individually configurable or configured molding machine-functional module arrangement. In particular, the at least one interface on the side of the molding machine enables direct coupling of at least one functional module; in particular, in such a way that a structure or housing structure on the side of the molding machine can be coupled or is coupled directly to a structure or housing structure of the respective functional module.

The system further comprises at least one functional module that can be individually assigned or associated with the at least one molding machine, forming an individually configured molding machine-functional module arrangement. The at least one functional module is configured to perform one or more work processes for processing plastic particles from at least one particle foam material to produce a particle foam molding. Depending on its specific functionality, the at least one functional module comprises at least one functional unit that is configured for carrying out one or more working processes for processing plastic particles from at least one particle foam material for producing a particle foam molding. A corresponding working process may, for example, be a corresponding supply process, a corresponding conveying process, a corresponding filling process, or a corresponding preparation process. The at least one functional module may comprise a housing-, rack- or frame-like structure, for example, on or in which the at least one functional unit is arranged or formed.

The at least one functional module comprises at least one interface for coupling, in particular functional and/or constructive, to the at least one automatic molding machine for forming an individually configured automatic molding machine functional module arrangement. The at least one interface can accordingly be a functional and/or constructive interface. A corresponding interface can therefore be configured to establish a functional and/or constructive coupling of the at least one functional module with the at least one automatic molding machine for forming an individually configured automatic molding machine functional module arrangement. In particular, respective functional module-side interfaces are configured to cooperate with respective molding machine-side interfaces to form an individually configurable or configured molding machine-functional module arrangement. The at least one interface on the side of the functional module in particular enables direct coupling of at least one molding machine; in particular in such a way that a structure or housing structure on the side of the functional module can be coupled or is coupled directly to a structure or housing structure of the respective molding machine.

It is of course conceivable that several molding machines can be coupled to one another via corresponding interfaces on the side of the molding machine. Similarly, it is conceivable that several functional modules can be coupled to each other via corresponding interfaces on the side of the functional module. It is also conceivable that several mutually coupled molding machines are coupled to several mutually coupled functional modules.

In principle, the system can therefore have several molding machines of the same or different configuration and/or several functional modules of the same or different configuration, i.e. in particular of the same or different functionality. In this context, respective molding machines and/or respective functional modules can, for example, be arranged in parallel and/or serial arrangement.

In all cases, corresponding individually configurable or configured molding machine functional module arrangements may be considered as individually configurable or configured manufacturing arrangements or machines for the production of particle foam moldings. Accordingly, the individual configuration of corresponding automatic molding machine functional module arrangements can be or be selected such that they enable self-sufficient production of particle foam moldings. This means that the supply media, materials, etc. required during operation of the system can be provided, prepared, processed and post-processed de-centrally and directly in the system.

The system further comprises at least one central data processing device implemented in terms of hardware and/or software. The central data processing device is configured on the basis of the or a configuration of the or an individually configured automatic molding machine functional module arrangement for generating (items of) operating information regulating and/or controlling the operation of the at least one automatic molding machine and/or the at least one functional module. The central data processing device is typically arranged to generate corresponding (items of) operating information based on (items of) detection information describing the configuration of the individually configured automatic molding machine functional module arrangement. The central data processing device may comprise one or more data processing elements implemented in terms of hardware and/or software, which execute data processing processes for generating corresponding items of operating information on the basis of a configuration of the or an individually configured automatic molding machine functional module arrangement or of data describing a corresponding individually configured automatic molding machine functional module arrangement, i.e., for example, corresponding items of detection information. In particular, the central data processing device is configured to generate corresponding items of operating information which enables fully automatable or automated regulation and/or control of the operation of the at least one automatic molding machine and/or the at least one functional module. Corresponding items of operating information may contain all the regulation and/or control information or regulations required for a completely automatable or automated regulation and/or control of the operation of the at least one automatic molding machine and/or of the at least one functional module. Consequently, a completely autonomous closed-loop and/or open-loop control of the operation of the at least one molding machine and/or of the at least one functional module and thus of the system can be performed on the basis of corresponding items of operating information.

Accordingly, the central data processing device can also be configured to control or regulate the operation of the entire system on the basis of corresponding operating information. The operation of the system can therefore be based on operating information which has been generated on the basis of the individual configuration of the system, i.e. in particular of a corresponding individually configured automatic molding machine functional module arrangement. The operating information that can be generated or is generated via the central data processing device can thus be tailored with regard to the configuration of a corresponding automatic molding machine functional module arrangement, which typically enables very efficient operation of the system. This also applies to the case in which a configuration of an automatic molding machine functional module arrangement changes, because in this case the change in the configuration of the automatic molding machine functional module arrangement can be taken into account by the central data processing device and correspondingly changed operating information can be generated.

As will be seen further, the central data processing device can transmit corresponding operating information, e.g. via data transmission devices on the side of the molding machine and/or on the side of the functional module, to the at least one molding machine and/or the at least one functional module, so that the respective operating information can be processed via respective closed-loop and/or open-loop control devices on the side of the molding machine and/or on the side of the functional module for closed-loop and/or open-loop control of the operation of the respective molding machine and/or the respective functional module.

The system therefore initially enables individually configurable or configured molding machine/functional module arrangements to be formed as required via the interaction of respective interfaces on the side of the molding machine with respective interfaces on the side of the functional module, so that on the one hand the system can be configured as required and on the other hand an existing configuration of a system can be changed as required, for example by rearranging existing molding machines and/or functional modules, adding molding machines and/or functional modules, removing molding machines and/or functional modules. By adding functional modules, existing functionalities of the system can be expanded as required or new functionalities can be added to the system as required. Accordingly, by removing functional modules, existing functionalities of the system can be reduced as required.

Furthermore, the system makes it possible via the central data processing device, in particular in an automatable or automated manner, to generate corresponding operating information on the basis of an individual configuration of an automatic molding machine functional module arrangement, so that the respective individually configured automatic molding machine functional module arrangement can be readily commissioned and operated. As mentioned, a corresponding commissioning or operation typically includes a control and/or regulation of the operation of the respective automatic molding machine and/or functional modules of the respective automatic molding machine-functional module arrangement, which in particular can be automated or automated.

All in all, an improved system for producing at least one particle foam molding from an expandable or expanded particle foam material is thus provided, in particular with regard to the possibility of an individual configuration.

As mentioned, corresponding interfaces on the side of the molding machine and/or on the side of the functional module can be functional and/or configuration interfaces. Concrete examples of corresponding interfaces are explained below in a non-exhaustive manner:

A corresponding interface of the at least one automatic molding machine can, for example, be configured as or comprise a connection device for connecting at least one, in particular conduit-like or -shaped, supply device for supplying the at least one automatic molding machine with at least one supply medium, in particular an electrical energy carrier, such as, for example, current or voltage, and/or a thermal energy carrier, such as, for example, a process fluid, and/or a pneumatic energy carrier, such as, for example, a pressurized gas. Alternatively or additionally, a corresponding interface of the at least one functional module can be configured as or comprise a connection device for connecting at least one, in particular conduit-like or conduit-shaped, supply device for supplying the at least one functional module with at least one supply medium, in particular an electrical energy carrier, such as, for example, current or voltage, and/or a thermal energy carrier, such as, for example, a process fluid, and/or a pneumatic energy carrier, such as, for example, a pressurized gas. Supply means, i.e. e.g. supply lines, for supplying the at least one automatic molding machine and/or the at least one functional module with at least one supply medium can therefore be connected to the respective automatic molding machine and/or the respective functional module via respective connection devices on the automatic side of the molding machine and/or on the side of the functional module.

A specific example of a connection device on the side of the molding machine can be or comprise a connection device for connecting at least one supply device for supplying the at least one mold device of the at least one molding machine with a liquid and/or gaseous energy carrier, in particular a process fluid, in particular steam and/or water. Corresponding connection devices may comprise one or more connection elements, such as, for example, connection sockets, flanges, etc.

Alternatively or additionally, a corresponding interface of the at least one automatic molding machine can be configured, for example, as a fastening device for fastening, in particular directly, the at least one automatic molding machine, in particular a structure of the at least one automatic molding machine, for example a structure of the at least one automatic molding machine in the form of a housing, frame or frame, to the at least one functional module, in particular a structure of the at least one functional module in the form of a housing, frame or frame, for example. Alternatively or additionally, a corresponding interface of the at least one functional module can be configured as, or comprise, a fastening device for fastening, in particular directly, the at least one functional module, in particular a structure of the at least one functional module, for example a structure of the at least one automatic molding machine, for example a structure of the at least one automatic molding machine, for example a structure of the at least one automatic molding machine, which structure is similar to a housing, frame or rack. Via respective fastening devices on the side of the molding machine and/or on the side of the functional module, direct fastenings of the at least one molding machine to the at least one functional module, and vice versa, can thus be produced. Corresponding fastening devices can comprise one or more fastening elements, such as, for example, form-fitting and/or force-fitting elements, such as, for example, clamping, screwing, tensioning or latching elements.

Alternatively or additionally, a corresponding interface of the at least one automatic molding machine can be configured as or comprise a data transmission device for the, in particular direct, transmission of data, in particular of corresponding operating information, to the at least one functional module, in particular to a data processing device of the at least one functional module which regulates and/or controls the operation of the at least one functional module. Alternatively or additionally, a corresponding interface of the at least one functional module can be configured as or comprise a data transmission device for the, in particular direct, transmission of data, in particular corresponding operating information, to the at least one automatic molding machine, in particular to a data processing device of the at least one automatic molding machine which regulates and/or controls the operation of the at least one automatic molding machine. Direct or indirect data transmissions between the at least one molding machine and/or the at least one functional module can therefore be established via respective data transmission devices on the side of the molding machine and/or side of the functional module. Corresponding data transmission devices may comprise one or more data transmission elements, such as data transmission connections (ports), data transmission antennas, etc. In all cases, a data transmission can take place via wired data transmission connections or wired data transmission protocols or via wireless data transmission connections (radio) or corresponding wireless data transmission protocols (radio protocols).

As indicated above, corresponding data transmission devices can be configured to transmit, i.e. in particular to send and/or receive, corresponding operating information generated by the central data processing device directly or indirectly, so that the respective operating information can be processed via respective automatic molding machine-side and/or functional module-side regulating and/or control devices for regulating and/or controlling the operation of the respective automatic molding machine and/or the respective functional module. Corresponding automatic molding machine-side and/or functional module-side regulation and/or control devices can form components of corresponding automatic molding machine-side and/or functional module-side data processing devices.

Individual, several or all interfaces on the side of the molding machine and/or interfaces on the side of the functional module can be at least partially, if necessary, completely, standardized, regardless of their specific configuration, in order to simplify the coupling of molding machines and/or functional modules.

As mentioned, corresponding functional modules are configured for carrying out one or more work processes for processing plastic particles from at least one expandable or expanded particle foam material to produce a particle foam molding. Specific examples of corresponding functional modules are explained below in a non-exhaustive manner:

The at least one or at least one functional module can be configured as or comprise a provision device for supplying at least one supply medium for the at least one automatic molding machine and/or for at least one further functional module. The term “provision” may thereby include a generation or storage of a supply medium. A corresponding supply medium may be, in particular, an electrical energy carrier, such as, for example, current or voltage, and/or a thermal energy carrier, such as, for example, a process fluid, and/or a pneumatic energy carrier, such as, for example, a pressurized gas. A corresponding supply medium or energy carrier can also be a process fluid or a temperature control medium.

A specific embodiment of a corresponding functional module can be, for example, a provision device or temperature control device for providing a temperature control medium, such as cooling water, for temperature control of the at least one automatic molding machine. A further specific embodiment of a corresponding functional module can be, for example, a provision device or process fluid provision device for providing a process fluid, such as steam, for tempering and, in conjunction therewith, forming a respective particle foam molding for bonding plastic particles of at least one expandable or expanded particle foam material located in the mold cavity of the at least one automatic molding machine. A further specific embodiment of a corresponding functional module can be, for example, a provision device or compressed gas provision device for providing a pressurized gas, such as compressed air, for example, for drying the at least one mold cavity of the at least one automatic molding machine.

Alternatively or additionally, the at least one or at least one functional module can be configured as or comprise a provision device for providing electrical energy and/or kinetic energy and/or pneumatic energy and/or thermal energy for the at least one automatic molding machine and/or for at least one further functional module. In this context, the term “provision” may include a generation or storage of electrical energy and/or kinetic energy and/or pneumatic energy and/or thermal energy. In the case of an electrical energy carrier, it may be, for example, electricity or voltage. A thermal energy carrier may be, for example, a temperature-controlled process fluid, such as steam and/or cooling water. A kinematic energy carrier may be, for example, motive or kinetic energy. A pneumatic energy carrier may be, for example, a pressurized gas.

A specific embodiment of a corresponding functional module can also be, for example, a provision device or storage device for providing or storing a temperature control medium, such as cooling water, for temperature control of the at least one automatic molding machine. A further specific embodiment of a corresponding functional module can also be here, for example, a provision device or storage device for providing or storing a temperature-controlled process fluid, such as steam. Another specific embodiment of a corresponding functional module may be a drive device for providing drive energy, for example for use in a further functional module, such as a compressed gas provision device. A further specific embodiment of a corresponding functional module can also be here, for example, a provision device or storage device for providing or storing a pressurized gas, such as compressed air, for example, for drying the at least one mold cavity of the at least one automatic molding machine.

Alternatively or additionally, the at least one functional module or at least one functional module can be configured as or comprise a power system, in particular a combined heat and power system, for providing electrical energy and/or kinetic energy and/or thermal energy. The energy provided on the side of the power system can, for example, be transferred to corresponding energy carriers and made available to the at least one automatic molding machine and/or a further functional module via suitable energy transport means. If the system comprises at least one functional module in the form of a corresponding power system, the energy required for operating the system can be generated completely independently of other energy sources, which can enable completely self-sufficient operation of the system.

Alternatively or additionally, the at least one functional module or at least one functional module can be configured as or comprise a provision device for providing an expandable or expanded particle foam material or corresponding plastic particles that can be processed or can be processed via the at least one automatic molding machine. A specific embodiment of a corresponding functional module can be, for example, a conveying device for conveying an expandable or expanded particle foam material or corresponding plastic particles, which can be processed or to be processed via the at least one automatic molding machine, into the at least one mold cavity of the at least one automatic molding machine.

Alternatively or additionally, the at least one functional module or at least one functional module may be configured as or comprise a treatment device for preparing a supply medium of the at least one automatic molding machine and/or at least one other functional module. The term “preparation” may include the modification of at least one chemical and/or physical parameter of the respective supply medium.

A specific embodiment of a corresponding functional module can be, for example, an influencing device or a softening device for chemical and/or physical softening of at least one process fluid, such as water, to be fed to the at least one automatic molding machine or a functional module. A further specific embodiment of a corresponding functional module can be, for example, an influencing device or treatment device for the chemical and/or physical treatment of at least one process fluid, such as water, discharged from the at least one automatic molding machine or a functional module.

Alternatively or additionally, the at least one functional module or at least one functional module can be configured as or comprise a checking device for checking a particle foam molding produced by means of the at least one automatic molding machine with respect to at least one checking criterion. A specific embodiment of a corresponding functional module can be, for example, an optical, gravimetric or tactile inspection device, which is configured to inspect a particle foam molding produced by means of the at least one automatic molding machine optically, gravimetrically or tactilely with regard to an optical inspection criterion, such as, for example, dimensions, surface quality, etc., for a gravimetric inspection criterion, to a gravimetric inspection criterion, such as weight, or a tactile inspection criterion, such as surface quality. Typically, a corresponding verification device is also arranged to generate verification information describing a corresponding verification result. Corresponding verification information can in turn be supplied to the central data processing device, which takes it into account when generating corresponding operating information.

The central data processing device can form a component of the at least one automatic molding machine. The central data processing device can therefore be structurally integrated on or in the at least one automatic molding machine, i.e. in particular in a corresponding, e.g. housing-, frame- or rack-like, structure of the at least one automatic molding machine. This arrangement can be advantageous, as the generation of the operating information generated on the side of the central data processing device can, if necessary, also be based on operating parameters of the at least one automatic molding machine. Taking into account corresponding operating parameters of the at least one automatic molding machine can enable even more demand-oriented and thus more efficient control and/or regulation of the operation of respective functional modules.

Of course, it is also conceivable in principle that the central data processing device is an independent or separate functional device of the system. In this case, too, the central data processing device can receive corresponding operating parameters of the at least one automatic molding machine, e.g. via a data link with the at least one automatic molding machine, and use them as the basis for generating corresponding operating information.

Basically independent of the arrangement of the central data processing device or of the location of the arrangement of the central data processing device, the central data processing device can be configured to generate corresponding operating information on the basis of operating status information describing at least one operating parameter and/or operating status of the at least one molding machine and/or of the at least one functional module. Consequently, operating parameters and/or operating states of the at least one automatic molding machine and/or of the at least one functional module can be taken into account when generating corresponding operating information, which makes it possible to control and/or regulate the operation of the entire system as required and thus efficiently.

In order to detect corresponding operating state information, the system can comprise a detection device which is configured to detect at least one operating parameter or state of the at least one automatic molding machine and/or of the at least one functional module and to generate operating state information describing at least one detected operating parameter or state of the at least one automatic molding machine and/or of the at least one functional module.

A corresponding detection device can comprise one or more detection elements which can be assigned or are assigned to the at least one automatic molding machine and/or the at least one functional module and which are configured to generate operating state information describing at least one operating state of the at least one automatic molding machine and/or the at least one functional module. Corresponding detection elements can, for example, be configured as sensor elements or comprise sensor elements which are, for example, configured to detect chemical and/or physical parameters, such as pressure, temperature, for example.

As mentioned, the central data processing device is typically arranged to generate corresponding operating information based on detection information describing the configuration of the individually configured automatic molding machine functional module arrangement. In order to generate corresponding detection information, the system may comprise at least one detection device implemented in terms of hardware and/or software, which is configured to detect detection information describing the configuration of the individually configured automatic molding machine functional module arrangement and to generate detection information describing the configuration of the individually configured automatic molding machine functional module arrangement.

A corresponding detection device can comprise one or more detection elements which can be assigned or are assigned to the at least one automatic molding machine and/or the at least one functional module and which are configured to generate detection information describing the arrangement of the at least one automatic molding machine and/or the at least one functional module within the individually configured automatic molding machine/functional module arrangement. Corresponding detection elements can be configured, for example, to detect machine-readable codes, data or information carriers, etc., which describe the selection, number and coupling of molding automat(s) and functional module(s). Corresponding detection elements can be configured, for example, as reading devices for reading machine-readable codes, data or information carriers, etc., or comprise such devices. Alternatively or additionally, corresponding detection elements can be configured, for example, for optical detection of the selection, number and coupling of molding machine(s) and functional module(s) within an individually configured molding machine/functional module arrangement. Corresponding detection elements can be configured, for example, as camera devices for reading out machine-readable codes, data or information carriers, etc., or can comprise such devices.

A configuration of an individually configured automatic molding machine functional module arrangement described by corresponding detection information can also be subjected by the central data processing device to a check with regard to at least one check criterion. For example, a plausibility check of an individually configured automatic molding machine-functional module arrangement is conceivable with regard to at least one plausibility criterion, which can be used, for example, to check whether the configuration of the automatic molding machine-functional module arrangement, i.e. in particular the selection, number and coupling of automatic molding machine(s) and functional module(s), is plausible. Further, for example, an efficiency check of an individually configured automatic molding machine/functional module arrangement with regard to at least one efficiency criterion is conceivable, on the basis of which it can be checked, for example, whether the configuration of the automatic molding machine/functional module arrangement, i.e. in particular the selection, number and coupling of automatic molding machine(s) and functional module(s), enables efficient operation of the system. Another example is a safety check of an individually configured automatic molding machine/functional module arrangement with regard to at least one safety criterion, which can be used, for example, to check whether the configuration of the automatic molding machine/functional module arrangement, i.e. in particular the selection, number and coupling of automatic molding machine(s) and functional module(s), enables safe operation of the system.

A second aspect of the invention relates to a method of forming an individually configured molding machine-functional module arrangement comprising at least one molding machine and at least one functional module. The method is characterized by the following steps:
providing at least one automatic molding machine, which comprises at least one mold device for processing expandable or expanded particle foam material for producing a particle foam molding, wherein the at least one automatic molding machine comprises at least one interface for coupling, in particular functionally and/or constructively, a functional module, which can be functionally assigned to the at least one automatic molding machine, for forming an individually configured automatic molding machine functional module arrangement;
providing at least one functional module which can be individually assigned to the at least one automatic molding machine to form an individually configured automatic molding machine functional module arrangement, wherein the at least one functional module comprises at least one interface for coupling, in particular functionally and/or constructively, to the at least one automatic molding machine to form an individually configured automatic molding machine functional module arrangement;
arranging the at least one automatic molding machine in a defined spatial arrangement and/or orientation, in particular relative to the at least one functional module, and/or arranging the at least one functional module in a defined spatial arrangement and/or orientation, in particular relative to the at least one automatic molding machine,
coupling of the at least one automatic molding machine to the at least one functional module, or vice versa, forming an individually configured automatic molding machine-functional module arrangement.

A third aspect of the invention relates to a method of manufacturing at least one particle foam molding from an expandable or expanded particle foam material. The method is characterized in that a system according to the first aspect of the invention is used to carry out the method.

All embodiments relating to the system according to the first aspect apply analogously to the process according to the second aspect of the invention and to the process according to the third aspect of the invention.

The invention is explained in more detail by means of exemplary embodiments in the drawings. The drawings show in:

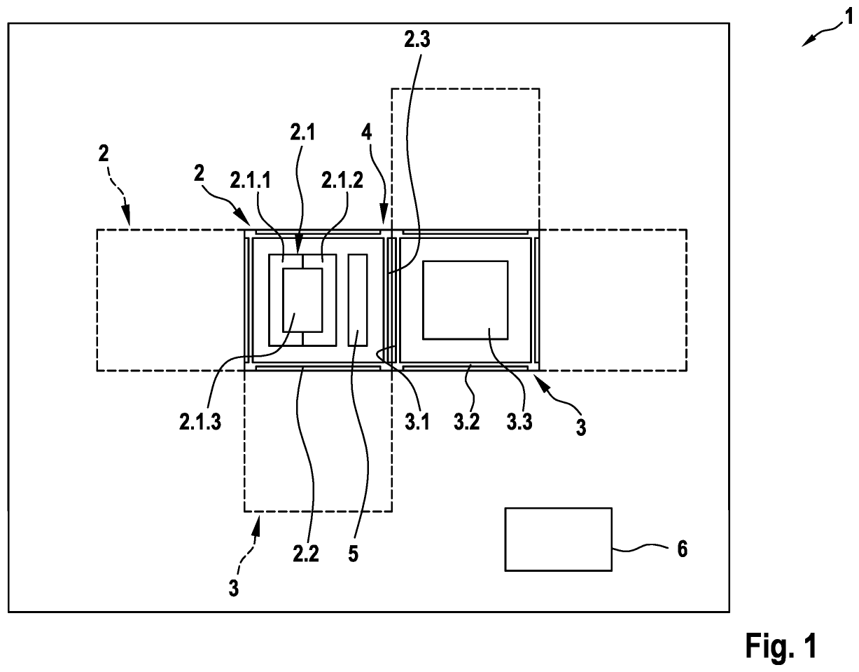

FIG. 1 a schematic diagram of a system for producing a particle foam molding according to an embodiment; and

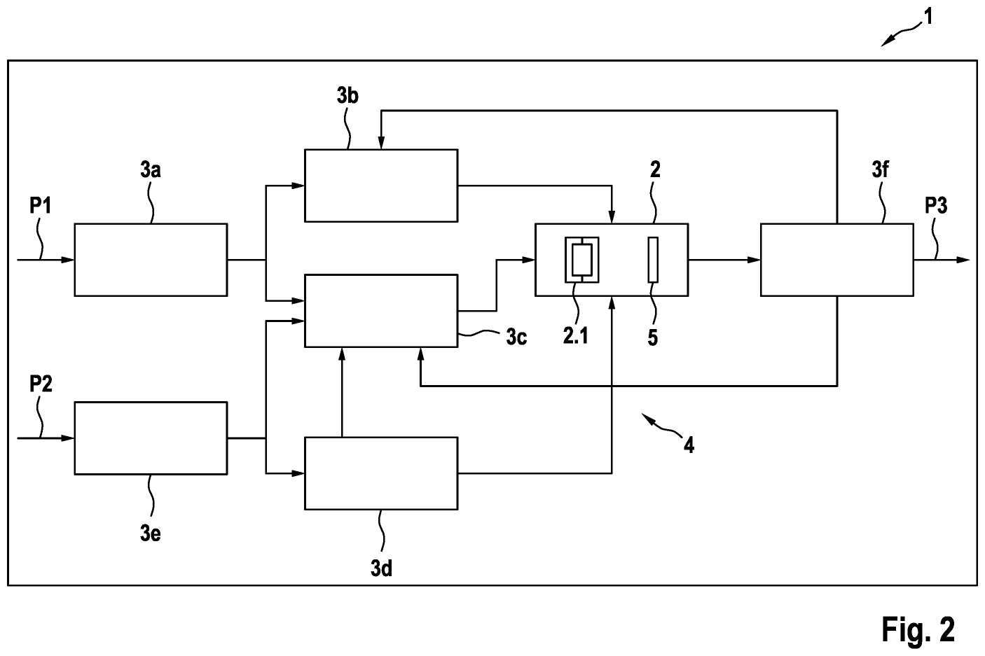

FIG. 2 a schematic diagram of a system for producing a particle foam molding according to a further embodiment.

FIG. 1 shows a schematic diagram of a system 1 for producing a particle foam component according to an embodiment.

The system 1 is configured for processing plastic particles of at least one expandable or expanded particle foam material, i.e., for example, plastic particles of expandable or expanded polyolefins, expandable or expanded polystyrenes, etc., for the production of particle foam moldings or particle foam components, and comprises, for this purpose, devices for carrying out one or more working processes for processing corresponding plastic particles for the production of a particle foam molding.

The term “working process” basically includes any process which can be carried out by means of system 1 and which is directly or indirectly connected with the processing of plastic particles from at least one expandable or expanded particle foam material for the production of a particle foam molding.

The system 1 comprises at least one automatic molding machine 2. The automatic molding machine 2 is configured for carrying out one or more processing processes for processing plastic particles from at least one particle foam material to produce a particle foam molding. The molding machine 2 may therefore also be referred to or deemed to be an apparatus for processing plastic particles of at least one expandable or expanded particle foam material. The automatic molding machine 2 comprises a mold device 2.1 for processing plastic particles of at least one expandable or expanded particle foam material to produce a particle foam molding.

The mold device 2.1 comprises a mold cavity 2.1.3 definable or defined by one or more mold elements 2.1.1, 2.1.2, within which plastic particles of at least one expandable or expanded particle foam material can be processed to form corresponding particle foam moldings. The molding machine 2 can comprise a housing-, frame- or rack-like structure 2.2, for example, on or in which at least the mold device 2.1 is arranged or formed.

The automatic molding machine 2 comprises at least one interface 2.3 for coupling, in particular functionally and/or constructively, at least one functional module 3 that can be functionally assigned or is assigned to the automatic molding machine 2 to form an individually configured automatic molding machine functional module arrangement 4. The interface 2.3 may accordingly be a functional and/or constructive interface. The interface 2.3 can thus be configured to establish a functional and/or constructive coupling of the automatic molding machine 2 with at least one functional module 3 that can be functionally assigned or is assigned to the automatic molding machine 2 for forming an individually configured automatic molding machine functional module arrangement 4. In particular, respective interfaces 2.3 on the side of the molding machine are configured to cooperate with respective interfaces 3.1 on the side of the functional module to form an individually configurable or configured molding machine functional module arrangement 4. The interface 2.3 on the side of the molding machine enables in particular a direct coupling of at least one functional module 3; in particular in such a way that a structure 2.2 or housing structure on the side of the molding machine can be or is directly coupled to a structure 3.2 or housing structure of the respective functional module 3.

The system 1 further comprises at least one functional module 3 that can be individually assigned or is assigned to the molding machine 2 with formation of the individually configured molding machine functional module arrangement 4. The functional module 3 is configured for carrying out one or more working processes for processing plastic particles from at least one particle foam material for producing a particle foam molding. Depending on its specific functionality, the functional module 3 comprises at least one functional unit 3.3, which is configured for carrying out one or more working processes for processing plastic particles from at least one particle foam material for producing a particle foam molding. A corresponding working process may be, for example, a corresponding supply process, a corresponding conveying process, a corresponding filling process, or a corresponding preparation process. The functional module 3 comprises the aforementioned, e.g. housing-, rack- or frame-like, structure 3.1 on or in which the at least one functional unit 3.3 is arranged or formed.

The functional module 3 comprises the likewise already mentioned at least one interface 3.1 for, in particular functional and/or constructive, coupling to the automatic molding machine 3 for forming the individually configured automatic molding machine functional module arrangement 4. The interface 3.1 may accordingly be a functional and/or constructive interface. The interface 3.1 can thus be configured to establish a functional and/or constructive coupling of the functional module 3 with the automatic molding machine 4 for forming the individually configured automatic molding machine functional module arrangement 4. In particular, respective functional module-side interfaces 3.1 are configured to cooperate with respective molding machine-side interfaces 2.3 to form the individually configurable or configured molding machine-functional module arrangement 4. The functional module-side interfaces 3.1 thereby enable in particular a direct coupling of the molding machine 2; in particular in such a way that the functional module-side structure 3.1 or housing structure can be coupled or is coupled directly to the structure 2.2 or housing structure of the molding machine 2.

As indicated by the dashed boxes, it is conceivable that several molding machines 2 can be coupled to each other via corresponding interfaces 2.3 on the side of the molding machine. Similarly, it is conceivable that several functional modules 3 can be or are coupled to one another via corresponding interfaces 3.1 on the side of the functional module. It is also conceivable that several mutually coupled molding machines 2 are coupled with several mutually coupled functional modules 3.

In principle, the system 1 can therefore have several automatic molding machines 2 of the same or different configuration and/or several functional modules 3 of the same or different configuration, i.e. in particular of the same or different functionality. In this context, respective molding machines 2 and/or respective functional modules 3 can, for example, be arranged in a parallel and/or serial arrangement.

The automatic molding machine functional module arrangements 4 may be considered as an individually configurable or configured manufacturing arrangement or machine for the production of particle foam moldings. Accordingly, the individual configuration of the automatic molding machine-functional module arrangement 4 can be or is selected such that it enables self-sufficient production of particle foam moldings. Consequently, supply media, materials, etc. required during operation of the system 1 can be provided, prepared, processed and post-processed de-centrally and directly in the system 1.

The system 1 further comprises a central data processing device 5 implemented in terms of hardware and/or software. The central data processing device 5 is configured to generate operating information regulating and/or controlling the operation of the automatic molding machine 2 and/or the functional module 3 on the basis of the or a configuration of the individually configured automatic molding machine functional module arrangement 4. The central data processing device 5 is typically arranged to generate corresponding operating information based on the detection information describing the configuration of the automatic molding machine functional module arrangement 4. The central data processing device 5 may comprise one or more data processing elements (not shown) implemented in terms of hardware and/or software, which execute data processing processes for generating corresponding operating information on the basis of the configuration of the automatic molding machine functional module arrangement 4 or of data describing the automatic molding machine functional module arrangement, i.e., for example, corresponding detection information. In particular, the central data processing device 5 is configured to generate corresponding operating information which enables fully automatable or automated regulation and/or control of the operation of the automatic molding machine 2 and/or the functional module 3. Corresponding operating information can contain all the regulation and/or control information or regulations required for a completely automatable or automated regulation and/or control of the operation of the automatic molding machine 2 and/or of the functional module 3. Consequently, a completely autonomous regulation and/or control of the operation of the molding machine 2 and/or of the functional module 3 can be carried out on the basis of corresponding operating information.

Accordingly, the central data processing device 5 can also be configured to control or regulate the operation of the entire system 1 on the basis of corresponding operating information. The operation of the system 1 can therefore be based on operating information which has been generated on the basis of the individual configuration of the system 1, i.e. in particular the configuration of the automatic molding machine functional module arrangement 4. The operating information that can be generated or is generated via the central data processing device 5 can thus be tailored with respect to the configuration of the automatic molding machine functional module arrangement 4, which typically enables very efficient operation of the system 1. This also applies to the case in which a configuration of the automatic molding machine functional module arrangement 4 changes, because in this case the change in the configuration of the automatic molding machine functional module arrangement 4 can be taken into account by the central data processing device 5 and correspondingly changed operating information can be generated.

As will be seen further, the central data processing device 5 can transmit corresponding (items of) operating information, e.g. via data transmission devices on the side of the molding machine and/or on the side of the functional module as examples of corresponding interfaces 2.3, 3.1, to the molding machine 2 and/or the functional module 3, so that the respective (item of) operating information can be processed via respective closed-loop and/or open-loop control devices (not shown) on the side of the molding machine and/or on the side of the functional module for regulating and/or controlling the operation of the molding machine 2 and/or the functional module 3.

The system 1 thus initially makes it possible to form individually configurable or configured automatic molding machine/functional module arrangements 4 as required via the interaction of respective interfaces 2.3 on the automatic side of the molding machine with respective interfaces 3.1 on the side of the functional module, so that on the one hand the system 1 can be configured as required and on the other hand an existing configuration of a system 1 can be changed as required, for example by re-arranging existing automatic molding machines 2 and/or functional modules 3, adding automatic molding machines 2 and/or functional modules 3, removing automatic molding machines 2 and/or functional modules 3. By adding functional modules 3, existing functionalities of the system 1 can be extended as required or new functionalities can be added to the system 1 as required. Accordingly, by removing functional modules 3, existing functionalities of the system 1 can be reduced, as required.

Furthermore, the system 1 makes it possible via the central data processing device 5, in particular in an automatable or automated manner, to generate corresponding (items of) operating information on the basis of the individual configuration of the automatic molding machine functional module arrangement 4, so that the automatic molding machine functional module arrangement 4 can be readily commissioned and operated. A corresponding commissioning or operation typically includes, as mentioned, a control and/or regulation of the operation of the automatic molding machine 2 and/or of the functional module 3 of the automatic molding machine functional module arrangement 4, which in particular can be automated or is automated.

As mentioned, corresponding interfaces 2.3, 3.1 on the side of the molding machine and/or on the side of the functional module can be functional and/or configuration interfaces. Specific examples of corresponding interfaces 2.3, 3.1 are explained below in a non-exhaustive manner:

A corresponding interface 2.3 of the automatic molding machine 2 can, for example, be configured as or comprise a connection device for connecting at least one, in particular conduit-like or -shaped, supply device for supplying the automatic molding machine 2 with at least one supply medium, in particular an electrical energy carrier, such as, for example, current or voltage, and/or a thermal energy carrier, such as, for example, a process fluid, and/or a pneumatic energy carrier, such as, for example, a pressurized gas. Alternatively or additionally, a corresponding interface 3.1 of the functional module 3 can be configured as or comprise a connection device for connecting at least one, in particular conduit-like or conduit-shaped, supply device for supplying the functional module 3 with at least one supply medium, in particular an electrical energy carrier, such as, for example, current or voltage, and/or a thermal energy carrier, such as, for example, a process fluid, and/or a pneumatic energy carrier, such as, for example, a pressurized gas. Supply means, i.e. e.g. supply lines, for supplying the molding machine 2 and/or the functional module 3 with at least one supply medium can thus be connected to the molding machine 2 and/or the functional module 3 via respective connection devices on the side of the molding machine and/or the side of the functional module.

A specific example of a connection device on the side of the molding machine can be or comprise a connection device for connecting at least one supply device for supplying the mold device 2.1 with a liquid and/or gaseous energy carrier, in particular a process fluid, in particular steam and/or water. Corresponding connection devices can comprise one or more connection elements, such as connection sockets, flanges, etc.

Alternatively or additionally, a corresponding interface 2.3 of the automatic molding machine 2 can be configured, for example, as a fastening device for fastening, in particular directly, the automatic molding machine 2, in particular the, for example, housing-, frame- or frame-like, structure 2.2 of the automatic molding machine 2, to the functional module 3, in particular the, for example, housing-, frame- or frame-like, structure 3.2 of the functional module 3, or can comprise such a structure. Alternatively or additionally, a corresponding interface 3.1 of the functional module 3 can be configured as or comprise a fastening device for fastening, in particular directly, the functional module 3, in particular the, for example, housing-, frame- or frame-like, structure 3.2 of the n functional module 3, to the molding machine 2, in particular the, for example, housing-, frame- or frame-like, structure 2.2 of the molding machine 2. Via respective fastening devices on the side of the molding machine and/or on the side of the functional module, direct fastenings of the molding machine 2 to the functional module 3, and vice versa, can thus be produced. Corresponding fastening devices can comprise one or more fastening elements, such as form-fitting and/or force-fitting elements, such as clamping, screwing, tensioning or latching elements.

Alternatively or additionally, a corresponding interface 2.3 of the automatic molding machine 2, as mentioned, can be configured as or comprise a data transmission device for the, in particular direct, transmission of data, in particular of corresponding operating information, to the functional module 3, in particular to a data processing device (not shown) of the functional module 3 that regulates and/or controls the operation of the functional module 3. Alternatively or additionally, a corresponding interface 3.1 of the functional module 3 can be configured as or comprise a data transmission device for the, in particular direct, transmission of data, in particular corresponding operating information, to the automatic molding machine 2, in particular to a data processing device of the automatic molding machine 2 that regulates and/or controls the operation of the automatic molding machine 2. Direct or indirect data transmissions between the molding machine 2 and/or the functional module 3 can thus be established via respective data transmission devices on the side of the molding machine and/or the side of the functional module. Corresponding data transmission devices may comprise one or more data transmission elements, such as data transmission ports, data transmission antennas, etc. In all cases, a data transmission can take place via wired data transmission connections or wired data transmission protocols or via wireless data transmission connections (radio) or corresponding wireless data transmission protocols (radio protocols).

As indicated above, corresponding data transmission devices can be configured to directly or indirectly transmit, i.e. in particular to send and/or receive, corresponding operating information generated on the side of the central data processing device 5, so that the respective operating information can be processed via closed-loop and/or open-loop control devices on the side of the molding machine and/or on the side of the functional module for the closed-loop and/or open-loop control of the operation of the molding machine 2 and/or of the functional module 3. Corresponding automatic molding machine-side and/or functional module-side regulation and/or control devices can form components of corresponding automatic molding machine-side and/or functional module-side data processing devices.

Individual, several or all interfaces 2.3 on the side of the molding machine and/or interfaces 3.1 on the side of the functional module can be at least partially, if necessary completely, standardized, regardless of their specific configuration, in order to simplify the coupling of molding machines 2 and/or functional modules 3.

As mentioned, the functional module 3 is configured for carrying out one or more working processes for processing plastic particles of at least one expandable or expanded particle foam material to produce a particle foam molding. Specific embodiments of the or a corresponding functional module 3 are explained below in a non-exhaustive manner:

The functional module 3 or at least one functional module 3 of the system 1 may be configured as or comprise a provision device for providing at least one supply medium for the automatic molding machine 2 and/or for at least one further functional module 3. In this context, the term “provision” may include a generation or storage of a supply medium. In particular, a corresponding supply medium may be an electrical energy carrier, such as, for example, current or voltage, and/or a thermal energy carrier, such as, for example, a process fluid, and/or a pneumatic energy carrier, such as, for example, a pressurized gas. A corresponding supply medium or energy carrier can also be a process fluid or a temperature control medium.

A specific embodiment of the functional module 3 may be, for example, a provision device or temperature control device for providing a temperature control medium, such as cooling water, for temperature control of the automatic molding machine 2. A further specific exemplary embodiment of the functional module 3 may be, for example, a provision device or process fluid provision device for providing a process fluid, such as steam, for tempering and, in conjunction therewith, forming a respective particle foam molding for bonding plastic particles of at least one expandable or expanded particle foam material located in the molding cavity 2.1.3 of the automatic molding machine 2. Another specific embodiment of the functional module 3 may be, for example, a provision device or compressed gas provision device for providing a pressurized gas, such as compressed air, for example, for drying the molding cavity 2.13 of the automatic molding machine 2.

Alternatively or additionally, the functional module 3 or at least one functional module 3 may be configured as or comprise a provision device for providing electrical energy and/or kinetic energy and/or pneumatic energy and/or thermal energy for the automatic molding machine 2 and/or for at least one further functional module 3. In this context, the term “provision” may include a generation or storage of electrical energy and/or kinetic energy and/or pneumatic energy and/or thermal energy. In the case of an electrical energy carrier, it may be, for example, electricity or voltage. A thermal energy carrier may be, for example, a temperature-controlled process fluid, such as steam and/or cooling water. A kinematic energy carrier may be, for example, motive or kinetic energy. A pneumatic energy carrier may be, for example, a pressurized gas.

A specific embodiment of the functional module 3 can also be here, for example, a provision device or storage device for providing or storing a temperature control medium, such as cooling water, for temperature control of the automatic molding machine 2. A further specific exemplary embodiment of the functional module 3 can also be here, for example, a provision device or storage device for providing or storing a temperature-controlled process fluid, such as steam. Another specific exemplary embodiment of the functional module 3 may be a drive device for providing drive energy, for example for use in another functional module 3, such as a compressed gas provision device. A further specific exemplary embodiment of the functional module 3 can also be, for example, a provision device or storage device for providing or storing a pressurized gas, such as compressed air, for example, for drying the mold cavity 2.1.3 of the automatic molding machine 2.

Alternatively or additionally, the functional module 3 or at least one functional module 3 can be configured as or comprise a power system, in particular a combined heat and power system, for providing electrical energy and/or kinetic energy and/or thermal energy. The energy provided on the side of the power system can, for example, be transferred to corresponding energy carriers and made available to the automatic molding machine 2 and/or a further functional module 3 via suitable energy transport means. Provided that the system 1 comprises at least one functional module 3 in the form of a corresponding power system, the energy required for the operation of the system 1 can be generated completely independently of other energy sources, which can enable completely self-sufficient operation of the system 1.

Alternatively or additionally, the functional module 3 or at least one functional module 3 may be configured as or comprise a provision device for providing an expandable or expanded particle foam material or corresponding plastic particles that can be processed or is to be processed via the automatic molding machine 2. A specific exemplary embodiment of a corresponding functional module 3 can here be, for example, a conveying device for conveying an expandable or expanded particle foam material or corresponding plastic particles, which can be processed or is to be processed via the molding machine 2, into the molding cavity 2.1.3 of the molding machine 2.

Alternatively or additionally, the functional module 3 or at least one functional module 3 may be configured as or comprise a treatment device for preparing a supply medium of the automatic molding machine 2 and/or at least one other functional module 3. The term “preparation” may include the modification of at least one chemical and/or physical parameter of the respective supply medium.

A specific exemplary embodiment of a corresponding functional module 3 can be, for example, an influencing device or a softening device for chemical and/or physical softening of at least one process fluid, such as water, to be supplied to the automatic molding machine 2 or a functional module 3. A further specific embodiment of the functional module 3 can be, for example, an influencing device or treatment device for chemical and/or physical treatment of at least one process fluid, such as water, discharged from the automatic molding machine 2 or the or another functional module 3.

Alternatively or additionally, the functional module 3 or at least one functional module 3 can be configured as or comprise a checking device for checking a particle foam molding produced by means of the automatic molding machine 2 with regard to at least one checking criterion. A specific embodiment of a corresponding functional module 3 can be, for example, an optical, gravimetric or tactile inspection device, which is configured to inspect a particle foam molding produced by means of the automatic molding machine 2 optically, gravimetrically or tactilely with regard to an optical inspection criterion, such as, for example, dimensions, surface quality, etc., for a gravimetric inspection criterion, to a gravimetric inspection criterion, such as weight, or a tactile inspection criterion, such as surface quality. Typically, a corresponding verification device is also configured to generate (items of) verification information describing a corresponding verification result. Corresponding (items of) verification information can in turn be supplied to the central data processing device 5, which takes it into account when generating corresponding operating information.

It can be seen from FIG. 1 that the central data processing device 5 can be part of the molding machine 2. The central data processing device 5 can thus be structurally integrated on or in the automatic molding machine 2, i.e. in particular in the structure 2.2 of the automatic molding machine 2, e.g. in the form of a housing, rack or frame. This arrangement can be advantageous as the generation of the operating information generated on the side of the central data processing device 5 can, if necessary, also be based on operating parameters of the molding machine 2. Taking into account corresponding operating parameters of the automatic molding machine 2 may enable an even more demand-oriented and thus more efficient control and/or regulation of the operation of the functional module 3 or respective functional modules 3.

In principle, it is also conceivable that the central data processing device 5 is an independent or separate functional device of the system 1. In this case, too, the central data processing device 5 can receive corresponding operating parameters of the molding machine 2, e.g. via a data connection existing with the molding machine 2, and use them as a basis for generating corresponding operating information.

In all exemplary embodiments, the central data processing device 5 can be configured to generate corresponding operating information on the basis of operating status information describing at least one operating parameter and/or operating status of the automatic molding machine 2 and/or of the functional module 3. Consequently, operating parameters and/or operating states of the automatic molding machine 2 and/or of the 3 functional module can be taken into account in the generation of corresponding operating information, which makes it possible to control and/or regulate the operation of the entire system 1 in a demand-oriented and thus efficient manner.

In order to detect corresponding operating state information, the system 1 may comprise a detection device (not shown), which is configured to detect at least one operating parameter or state of the molding machine 2 and/or of the functional module 3 and to generate operating state information describing at least one detected operating parameter or state of the molding machine 2 and/or of the functional module 3.

A corresponding detection device can comprise one or more detection elements which can be assigned or are assigned to the automatic molding machine 2 and/or the functional module 3 and which are configured to generate operating (items of) status information describing at least one operating status of the automatic molding machine 2 and/or the functional module 3. Corresponding detection elements can, for example, be configured as sensor elements or comprise sensor elements which are, for example, configured to detect chemical and/or physical parameters, such as pressure, temperature, for example.

As mentioned, the central data processing device 5 is configured to generate corresponding operating information based on detection information describing the configuration of the individually configured automatic molding machine functional module arrangement 4. In order to generate corresponding (items of) detection information, the system 1 may comprise a detection device 6 implemented in terms of hardware and/or software, which is configured to detect (items of) detection information describing the configuration of the individually configured automatic molding machine functional module arrangement 4 and to generate detection information describing the configuration of the individually configured automatic molding machine functional module arrangement 4.

The detection device 6 may comprise one or more detection elements (not shown) which can be assigned or are assigned to the automatic molding machine 2 and/or the functional module 3 and which are configured to generate detection information describing the arrangement of the automatic molding machine 2 and/or the functional module 3 within the individually configured automatic molding machine/functional module arrangement 4. Corresponding detection elements may be configured, for example, to detect machine-readable codes, data or information carriers, etc., which describe the selection, number and coupling of molding automat(s) 2 and functional module(s) 3. Corresponding detection elements can be configured, for example, as reading devices for reading machine-readable codes, data or information carriers, etc., or comprise such. Alternatively or additionally, corresponding detection elements can be configured, for example, for optical detection of the selection, number and coupling of molding machine(s) 2 and functional module(s) 3 within an individually configured molding machine-functional module arrangement 4. Corresponding detection elements can be configured, for example, as camera devices for reading out machine-readable codes, data or information carriers, etc., or comprise such devices.

A configuration of an individually configured automatic molding machine functional module arrangement 4 described by corresponding detection information can also be subjected to a check on the side of the central data processing device 5 with regard to at least one check criterion. For example, a plausibility check of an individually configured automatic molding machine-functional module arrangement 4 with regard to at least one plausibility criterion is conceivable, on the basis of which it can be checked, for example, whether the configuration of the automatic molding machine-functional module arrangement 4, i.e. in particular the selection, number and coupling of automatic molding machine(s) 2 and functional module(s) 3, is plausible. Further, for example, an efficiency check of an individually configured automatic molding machine-functional module arrangement 4 with regard to at least one efficiency criterion is conceivable, by means of which it can be checked, for example, whether the configuration of the automatic molding machine-functional module arrangement 4, i.e. in particular the selection, number and coupling of automatic molding machine(s) 2 and functional module(s) 3, enables efficient operation of the system 1. Further, for example, a safety check of an individually configured automatic molding machine-functional module arrangement 4 with regard to at least one safety criterion is conceivable, by means of which it can be checked, for example, whether the configuration of the automatic molding machine-functional module arrangement 4, i.e. in particular the selection, number and coupling of automatic molding machine(s) 2 and functional module(s) 3, enables safe operation of the system 1.

FIG. 2 shows a schematic diagram of a system 1 for producing a particle foam molding according to a further embodiment.

FIG. 2 shows an example of a specific configuration of a system 1 with an individually configured automatic molding machine functional module arrangement 4, the components of which are explained in more detail.

The system 1 first comprises an automatic molding machine 2 corresponding to that shown in FIG. 1.

As a first functional module 3, the system 1 initially comprises a first treatment device 3a for treatment of a supply medium of the automatic molding machine 2 and/or at least one other functional module 3. The first treatment device 3a is connected to an inlet of a supply medium, i.e., for example, water, indicated by the arrow P1. The first treatment device 3a can be configured for softening the supply medium supplied to it.

As a second functional module 3, the system 1 comprises a second treatment device 3b connected to the first treatment device 3a for processing the supply medium softened via the first treatment device 3a for use in the automatic molding machine 2 and for use in a third functional module 3 in the form of a steam generation device 3c.

As a third functional module 3, the system 1 comprises the aforementioned steam generation device 3c. The steam generation device 3c serves to provide steam or superheated steam as an exemplary process fluid for the automatic molding machine 2 and is connected to it accordingly.

As a fourth functional module 3, the system 1 comprises the aforementioned compressed air generation device 3d. The compressed air generation device 3d serves on the one hand to provide compressed air as a further exemplary process fluid for the automatic molding machine 2 and is connected to it accordingly. The thermal energy possibly generated during the provision, i.e. in particular the generation, of compressed air can be made available to the steam generation device 3c; accordingly, the compressed air generation device 3d is also connected to the steam generation device 3c.

As a fifth functional module 5, the system 1 comprises a power system 3e. The power system 3e is configured to provide electrical and/or kinematic energy, which can be made available on the one hand—this applies in particular to kinematic energy—to the compressed air generation device 3d for generating compressed air and on the other hand—this applies in particular to thermal energy—to the steam generation device 3c; accordingly, the power system is also connected to the compressed air generation device 3d and the steam generation device 3c. The power system 3e is connected to an inlet of a fuel, i.e., e.g., gasoline, diesel, methanol, hydrogen, etc., indicated by the arrow P2.

As a sixth functional module 3, the system 1 comprises a collecting device 3f arranged downstream of the automatic molding machine 2 for used process fluid supplied from the automatic molding machine 2, which can be divided, if necessary via a heat exchanger, into two return flows, i.e. on the one hand a return flow for cold process fluid fed to the second treatment device 3b and on the other hand a return flow for hot process fluid fed to the steam generation device 3c. Accordingly, the collecting device 3f is connected on the one hand to the second treatment device 3b and on the other hand to the steam generating device 3c. The arrow P3 indicates the possibility of discharging any wastewater present from the collecting device 3f.

It should be mentioned again that the configuration of the system 1 shown in FIG. 2 is purely exemplary, so that individual, several or all of the described functional modules 3 can be changed, for example in their selection, number and coupling.

Based on FIG. it can be seen that a method of forming an individually configured molding machine functional module arrangement 4 can include the following steps:
providing at least one automatic molding machine 2, which comprises at least one mold device 2.1 for processing expandable or expanded particle foam material for producing a particle foam molding, wherein the at least one automatic molding machine 2 comprises at least one interface 2.3 for coupling, in particular functionally and/or constructively, a functional module 3, which can be functionally assigned to the at least one automatic molding machine 2, for forming an individually configured automatic molding machine functional module arrangement 4;
providing at least one functional module 3 that can be individually assigned to the at least one automatic molding machine 2 to form an individually configured automatic molding machine functional module arrangement 4, wherein the at least one functional module 3 comprises at least one interface 3.1 for coupling, in particular functionally and/or constructively, to the at least one automatic molding machine 2 to form an individually configured automatic molding machine functional module arrangement 4;
arranging the at least one automatic molding machine 2 in a defined spatial arrangement and/or orientation, in particular relative to the at least one functional module 3, and/or arranging the at least one functional module 3 in a defined spatial arrangement and/or orientation, in particular relative to the at least one automatic molding machine 2,
coupling the at least one automatic molding machine 2 to the at least one functional module 3, or vice versa, forming an individually configured automatic molding machine-functional module arrangement 4.

A corresponding system 1 can also be used to implement a process for producing at least one particle foam molding from an expandable or expanded particle foam material.

1. System (1) for producing at least one particle foam molding from an expandable or expanded particle foam material, comprising:
at least one automatic molding machine (2) which comprises at least one mold device (2.1) for processing expandable or expanded particle foam material for producing a particle foam molding, wherein the at least one automatic molding machine (2) comprises at least one interface (2.3) for coupling, in particular functionally and/or constructively, a functional module (3) which can be functionally assigned to the at least one automatic molding machine (2) in order to form an individually configured automatic molding machine functional module arrangement (4);
at least one functional module (3) which can be individually assigned to the at least one automatic molding machine (2) to form an individually configured automatic molding machine functional module arrangement (4), wherein the at least one functional module (3) comprises at least one interface (3.1) for coupling, in particular functionally and/or constructively, to the at least one automatic molding machine (2) to form an individually configured automatic molding machine functional module arrangement (4);
at least one central data processing device (5) which, on the basis of the configuration of the individually configured automatic molding machine functional module arrangement (4), is configured to generate operating information which regulates and/or controls the operation of at least one functional module (3).

2. System according to claim 1, characterized in that the at least one molding machine (2) comprises a housing-, rack- or frame-like structure, for example, on or in which the at least one mold device (2.1) is arranged or formed.

3. System according to one of the preceding claims, characterized in that the at least one interface (2.3) of the at least one automatic molding machine (2) is configured as or comprises a connection device for connecting at least one, in particular conduit-like or conduit-shaped, supply device for supplying the at least one automatic molding machine (2) with at least one supply medium, in particular a process fluid, and/or
the at least one interface (3.1) of the at least one functional module (3) is configured as or comprises a connection device for connecting at least one supply device, in particular a conduit-like or conduit-shaped supply device, for supplying the at least one functional module (3) with at least one supply medium, in particular a process fluid.

4. System according to one of the preceding claims, characterized in that the at least one interface (2.1) of the at least one automatic molding machine (2) is configured as or comprises a fastening device for fastening, in particular directly, the at least one automatic molding machine (2), in particular a housing-like, rack-like or frame-like structure, of the at least one automatic molding machine (2) to the at least one functional module (3), in particular a housing-, rack- or frame-like structure of the functional module (3); and/or
the at least one interface of the at least one functional module (3) is configured as or comprises a fastening device for fastening, in particular directly, the at least one functional module (3), in particular a housing-, rack- or frame-like structure of the at least one functional module (3), to the at least one automatic molding machine (2), in particular a housing-, rack- or frame-like structure of the at least one automatic molding machine (2).

5. System according to one of the preceding claims, characterized in that the at least one interface (2.3) of the at least one automatic molding machine (2) is configured as or comprises a data transmission device for the, in particular direct, transmission of data, in particular corresponding operating information, to the at least one functional module (3), in particular to a data processing device of the at least one functional module (3) which regulates and/or controls the operation of the at least one functional module (3); and/or
the at least one interface (3.1) of the at least one functional module (3) is configured as or comprises a data transmission device for the, in particular direct, transmission of data, in particular corresponding operating information, to the at least one automatic molding machine (2), in particular to a data processing device of the at least one automatic molding machine (2) which regulates and/or controls the operation of the at least one automatic molding machine (2).

6. System according to one of the preceding claims, characterized in that the at least one functional module (3) is configured as or comprises a provision device for providing at least one supply medium for the at least one automatic molding machine (2) and/or for at least one further functional module (3).

7. System according to one of the preceding claims, characterized in that the at least one functional module (3) is configured as or comprises a provision device for providing electrical energy and/or kinetic energy and/or pneumatic energy and/or thermal energy for the at least one automatic molding machine (2) and/or for at least one further functional module (3).

8. System according to one of the preceding claims, characterized in that the at least one functional module (3) is configured as or comprises a power system, in particular a combined heat and power system, for providing electrical energy and/or thermal energy.

9. System according to one of the preceding claims, characterized in that the at least one functional module (3) is configured as or comprises a provision device for providing an expandable or expanded particle foam material that can be processed or is to be processed via the at least one automatic molding machine (2).

10. System according to one of the preceding claims, characterized in that the at least one functional module (3) is configured as or comprises a treatment device for treatment of a supply medium of the at least one automatic molding machine (2) and/or at least one other functional module (3).

11. System according to one of the preceding claims, characterized in that the central data processing device (5) forms part of the at least one automatic molding machine (2).

12. System according to one of the preceding claims, characterized in that the central data processing device (5) is configured to generate corresponding operating information based on detection information describing the configuration of the individually configured molding machine functional module arrangement (4).

13. System according to claim 12, characterized by a detection device which is configured to detect an item of detection information describing the configuration of the individually configured automatic molding machine functional module arrangement (4) and to generate an item of detection information describing the configuration of the individually configured automatic molding machine functional module arrangement (4).

14. System according to one of the preceding claims, characterized in that the central data processing device (5) is configured to generate corresponding operating information on the basis of operating state information describing at least one operating state of the at least one automatic molding machine (2) and/or at least one operating state of the at least one functional module (3) for generating operating information regulating and/or controlling the operation of the at least one functional module (3).

15. System according to claim 14, characterized by a detection device which is configured to detect operating state information describing at least one operating state of the at least one automatic molding machine and/or the at least one functional module.

16. Method of forming an individually configured automatic molding machine functional module arrangement (4) comprising at least one automatic molding machine (2) and at least one functional module (3), characterized by the steps:
providing at least one automatic molding machine (2) which comprises at least one mold device (2.1) for processing expandable or expanded particle foam material for producing a particle foam molding, wherein the at least one automatic molding machine (2) comprises at least one interface (2.3) for coupling, in particular functionally and/or constructively, a functional module (3) which can be functionally assigned to the at least one automatic molding machine (2) for forming an individually configured automatic molding machine functional module arrangement (4);
providing at least one functional module (3) which can be individually assigned to the at least one automatic molding machine (2) to form an individually configured automatic molding machine functional module arrangement (4), wherein the at least one functional module (3) comprises at least one interface (3.1) for coupling, in particular functionally and/or constructively, to the at least one automatic molding machine (2) to form an individually configured automatic molding machine functional module arrangement (4);
arranging the at least one automatic molding machine (2) in a defined spatial arrangement and/or orientation, in particular relative to the at least one functional module (3),
arranging the at least one functional module (3) in a defined spatial arrangement and/or orientation, in particular relative to the at least one automatic molding machine (3),
coupling the at least one automatic molding machine (2) to the at least one functional module (3), or vice versa, forming an individually configured automatic molding machine functional module arrangement (4).

17. Method for producing at least one particle foam molding from an expandable or expanded particle foam material, characterized in that a system (1) according to one of claims 1 to 15 is used to carry out the method.
